(19) United States
(12) Patent Application Publication
(10) Pub. No.: US 2006/0167983 A1
(43) Pub. Date: Jul. 27, 2006

(54) Inter-networked knowledge services (INKS)

(75) Inventor: Christopher Gabriel Webb, Tustin, CA (US)

Correspondence Address: Christopher G. Webb, 14661 Emerywood Road, Tustin, CA, 92780, US

(73) Assignee: Exacore Corporation, Los Angeles, CA (US)

(21) Appl. No.: 11/031,890

(22) Filed: Jan. 7, 2005

(51) Int. Cl. G06F 15/16

(52) U.S. Cl. 709/203

(57) ABSTRACT

Inter-Networked Knowledge Services (INKS) is a software platform designed to deliver IT services with expert functions and data access spanning many computing environments. INKS is a 4-tier architecture delivering remote applications to a lightweight client, bringing disparate systems together within and between diverse organizations. Through web services, INKS enables these systems to interoperate smoothly. Instead of procuring software and its requisite platforms, each party contracts for process functionality and data services. INKS is a low-cost infrastructure which leverages existing technology investments and installations, simplifying integration across the boundaries of organizations and their networks

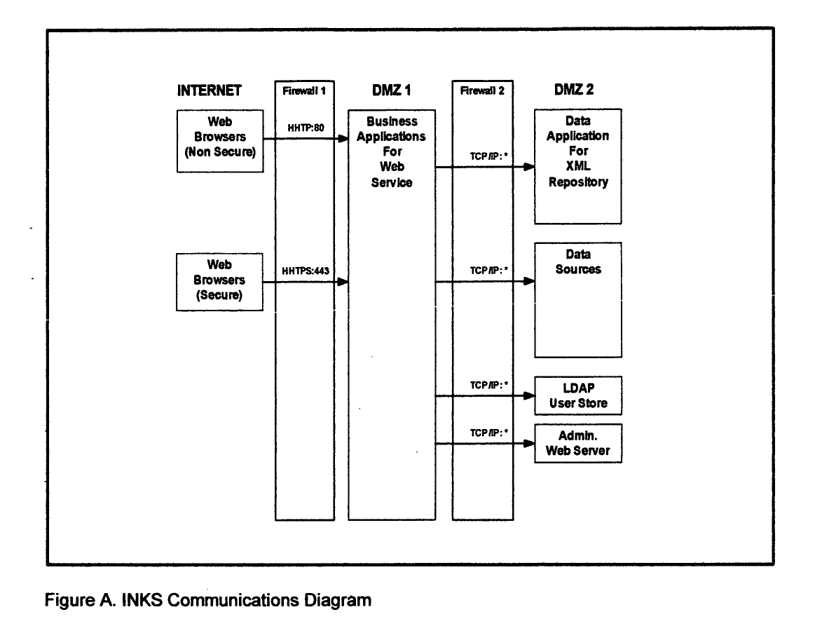

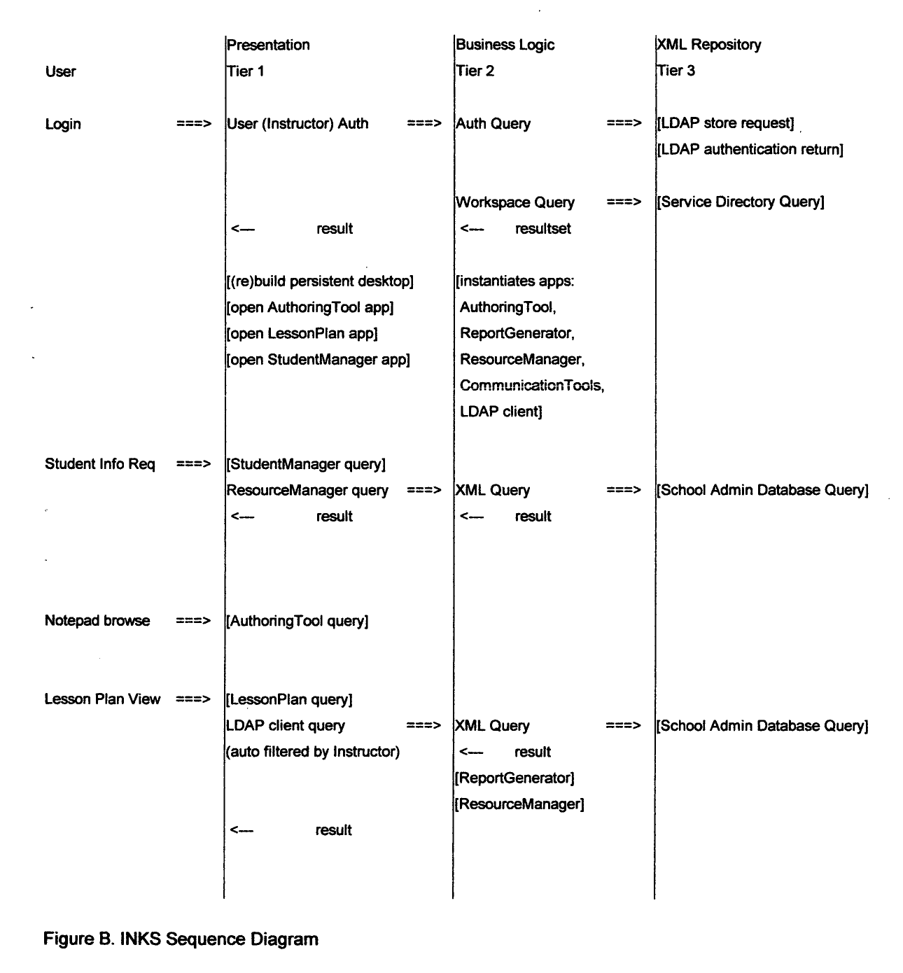

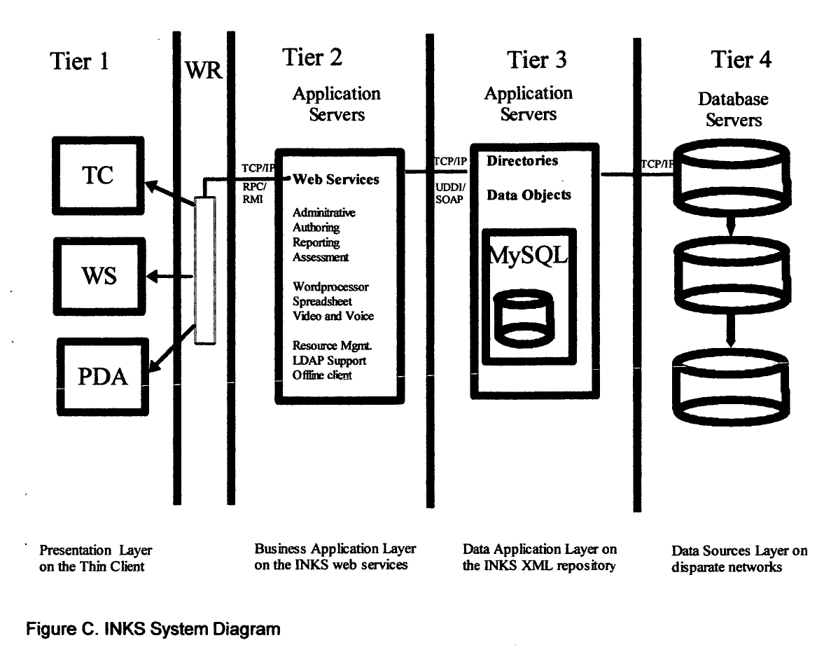

INKS is a distributed system using the Model-View-Controller architecture created in either Java or ASP.NET and is described best in a four-tier design:

Tier 1—Presentation layer (Lightweight Client)

Tier 2—Business Applications (Web Services)

Tier 3—Data Applications (XML Repository)

Tier 4—Data Sources (Disparate Databases)

Inter-Networked Knowledge Services (INKS) is a software platform designed to deliver IT services with expert functions and data access spanning many computing environments. INKS is based on a 4-tier system architecture that delivers remote applications to a thin-client and provides services and information from disparate systems in diverse organizations. INKS allows various parties to engage with its own web services providers and creates standard interfaces that permit all these services to inter-operate smoothly. In other words, instead of procuring software and its requisite platforms each party would contract for process functionality and data services. INKS is the middleware infrastructure for wireless networks (WiMAX, CDMA) that offers the opportunity to leverage existing installations in order to simplify integration across the boundaries of organizations and their networks.

### PRIOR ART

The following summaries of previous work related to the INKS software demonstrate the state of research and need for innovation.

High Level Assembler Metamodel (U.S. Pat. No. 6,775,680)

Describes a messaging model comprised of multiple languages (such as a markup language). Messages are converted between the client and server languages based on an extensible connector metamodel.

File System with Access and Retrieval of XML Documents (U.S. Pat. No. 6,745,206)

An XML-aware file system exploits attributes encoded in an XML document. The dynamic structure is based upon content, which is extracted using an inverted index according to attributes and values defined by the XML structure.

System and Method for Interactive Giving Tutorial Information (U.S. Pat. No. 6,612,842)

The system operates in a command driven custom-made or review mode. The former yields tutorial interfaces, courses and review intervals. The latter yields study courses, and examination questions tailored to the customers' learning conditions.

Apparatus, and Associated Method, for Communicating Content in a Bandwidth Constrained Communication System (U.S. Pat. No. 6,624,769)

System utilizes codec-class technology to minimize size of vector artwork transmitted over low speed connections.

Efficient Server Side Data Retrieval for Execution of Client Side Applications (U.S. Pat. No. 6,615,253)

A system, method, and article of manufacture are provided for data retrieval effiency. Data is bundled into a data structure by the server in response to the single call.

Presentation Services Patterns in a Netcentric Environment (U.S. Pat. No. 6,640,249)

Defined is a reusable client-side business logic model designed with special consideration for multiple and/or volatile user interfaces. Included in the pattern are data validation rules.

Architecture and Protocol for a Wireless Communication Network to Provide Scalable Web Services to Mobile Access Devices (U.S. Pat. No. 6,785,255)

Communication between the Application Server (AS) and portable devices is performed using standard Internet Protocol (IP). The AS includes a Client Proxy Server (CPS) that interfaces to applications on the server and lightens data source workload.

Context Sensitive Web Services (U.S. Pat. No. 6,714,778)

Described is a web service system augmented by a context inference engine. The result of such utilizes sensor signal reception to yield a user interface tailored to a wide range of devices with minimal development impact on the Application Server (AS)

Method and System for Automatically Configuring a Client-Server Network U.S. Pat. No. 6,687,733)

The system is comprised of a metaserver, a service used to discover and deliver other services. Based on authorization, clients may add, remove or modify available services through a controller via an external communications switch.

Base Services Patterns in a Netcentric Environment (U.S. Pat. No. 6,742,015)

The netcentric environment employs and depends on the following well-known patterns: Batch, Process Pipeline and Abstraction Factory. This enables homogenous batch processes, highly configurable communication between said batches, and requisite system extensibility, respectively.

What is claimed is:

1. It my claim that a lightweight client provides a user interface on the presentation tier of the system. This lightweight client initializes a secure shell remote session using a native X-Windows-based terminal service. This is basic to the OSI Reference Model where security checks are established in the link and network layers well below the session and presentation layers. The presentation layer invokes an authentication class to load services from the LINUX servers. Biometrics are captured upon authentication system and subsequent requests to the service's wireless router. Regardless of the client operating system, all web services are instantiated in client memory and not stored locally on the hard drive. The lightweight client does not require a hard disc drive. All data application objects will reside in the server. The services will be loaded directly on the client and access client memory, input/output, and terminal services. The lightweight client will be launched to parse XML to display the user interface in a browser-based service. For example, the graphical user interface can be generated using NetBeans combined with Java Server Pages (JSP) to for flow control and URL management with the control JavaBean in the javax class. Java Server pages Standard Tag Library is heavily utilized to encapsulate the core functionality and support common, structural tasks such as iteration and conditionals, tags for manipulating XML documents, internationalization tags, and SQL tags.

2. It is my claim that a group of web services establish the business applications layer. The web service instance is created upon the client request via wireless router. The session variables and encryption keys are generated upon authentication are shared in connection between Presentation (Tier 1) and the Business (Tier 2) and Data Application (Tier 3) layers. The encryption keys include hardware (MAC address) information combined with user biometrics (fingerprints and facial scans) using a triple level of proprietary processing and storage. The business application (Tier 2) pools connections to the data application (Tier 3) separately for high availability. All client requests are handled by the Business Application layer without directly accessing the data application layer. Data connections are optimized and limited between Tiers 2 and 3. If the system is compromised via the client remote session connection, the attacker can only access the data application layer and not the data sources (Tier 4). All session variables between Tiers 1-2, and encrypted connections between Tiers 1-2 and Tiers 2-3 must be in place for objects to be served to the client. All modifications are completed by Tier 2 to both Tier 1 and Tier 3 via the same encrypted requests—any corruption or modification is applied to Tier 3 by Tier 2 and never to Tier 4 by Tier 1. All business logic including system rules, classroom and roster functions, and objects are loaded on the server (LINUX) and made available through the interface created by the web service (Java Bean and Container). The interface is then published to the client-side using remote method invocation (RMI) over HTTP/S for encrypted request handling within a secure shell (SSH) session. INKS uses WS-Trust language for secure messaging to the between tiers.
INKS define user types with groups of functions composing a service. The functions are then delivered to a wireless or broadband lightweight client. Knowledge services are made available from a Tier 2 registry of services and directory of sources in Tier 3.
The system is published as a web service and is included in global registries using universal description, discovery, and integration (UDDI). The standard of UDDI is maintained by the development community and used to interface through the web services description language (WSDL). The WSDL service descriptor is an extensible markup language (XML) document. UDDI is an XML-based global resource registry used to list services on the Internet. Finally, lightweight directory access protocol (LDAP) is used together with XML to integrate disparate data sources.
Web services subscriptions are described by the WS-Eventing specification: a protocol that allows web services to subscribe to or accept subscriptions for event notification messages. A mechanism for registering interest is needed as web services sets often receive such messages unknown and will change over time. This model provides extensibility for sophisticated subscriptions. Integrated web services (IWS) include a word processor, spreadsheet, videoconference and voice communication tools. A Service Manager navigates all available IWS through all UDDI registries and is itself an IWS. Dynamic IWS include LDAP Client wrappers, Report Viewer, and Change Control Manager that provides a history of all things performed, through logs created per instantiation of the web service.
An example of a web service would be the modules loaded to enable a learning desktop to be provided to the lightweight client. The system's learning desktop features include but are not limited to: Resource management, LDAP support, Offline Learning Client, Authoring tool, Report generation tool, and Assessment tool:
Resource management is control of the physical assets including locations, rooms, instructors, and other actors in the system;
LDAP support is the use of directory servers to manage user information across multiple instances on the server. This includes the composition and maintenance of class rosters. The system will roster each student individually or as members of a group and roster all. This functionality is intended to mimic the traditional classroom as much as possible;
The Offline Learning Client allows users to take courses while disconnected from their networks which benefits the students on family or school outings. Notes and references can be made without running the full system normally;
The Authoring tool allows the creation and maintenance of courses that are composed of many content types such as web-based, file system based, and classroom-based. The authoring tool is delivered as a web service to the content author. The content anticipated will be both data (html, jpeg, etc.) and meta-data categories per the SCORM guidelines. The Authoring tool then prepares an XML package for publishing on the system running on the server;
The Report generation feature allows an administrator to provide system output in many formats (html, pdf, xml, txt, csv) as follows: catalog, enrollment, progress, resource usage, and system status;
The Assessment tool provides a dynamic metric for teachers to measure progress per course or student. This feature can be a simple XML output from the database of roster-based performance or it can be a presentation of a course-based progress report.

3. It Is my claim that an XML repository operate on Application Servers (AS) establishing a data applications layer. The data application is a server similar to Tier 2, but maintains information in tables and rows (MySQL) populated with XML formatted data. All data import/export and normalization is performed on Tier 3 for performance and security reasons. Using SOCKS to configure the data source access over TCP/IP, a simple object access protocol (SOAP) connection can be made through multiple firewalls. This connection is refreshed at intervals or maintained for continuous data access for all web services. Each data application that accesses this SOAP connection is created through the implementation of data-type definitions (DTDs) and accessed using extensible style sheet language transformations (XLST). User authentication service handles single sign on functions. The data applications replicate themselves and provide Quality of Service and Class of Service descriptions (Class of Service describes a class of data of XML repository).
Quality of information is present whether it has been reviewed, validated and approved by data owner. In the case of a Microsoft SQL Server database, the XML repository will create an OLE object bridge using the Microsoft Foundation Classes (MFC) and utilize the Java Runtime Environment (JRE) to implement SOAP. Templates can be created from data sources that are commonly found to reduce the amount of initial data application development required for the XML repository to work. The data archives maintained in the XML repository are accessed from the business application directly connecting to external applications hosted outside the SAN. The web service utilizes universal description, discovery, and integration (UDDI) and web services description language (WSDL) to connect external services securely to the client. The wireless routing hardware combines with the software application layers to establish a trustworthy system. The system adapts to changing user needs by integrating services and presenting a GUI through XML parsed on a system browser that runs on the server-side from the business application and XML repository. A secure WAN (S/WAN) is required by for interactions between Tier 2 and Tier 3. The purpose of an S/WAN is to create a secure Virtual Private Network through public channels, such as the internet. This is attained via a symmetrically encrypted transport layer, with public key based link-level authentication. The implementation of such utilizes LINUX firewalling combined with LINUX S/WAN technologies. As is customary with open source projects, the close scrutiny of peer review enhances the trustworthiness of its S/WAN and firewalling features. Using IETF drafted IPsec, two or more dedicated firewalls bond together to form a complete S/WAN solution. IPTABLES technology enables robust firewalling both in and outside of the S/WAN, maximizing the user base to fine tune secure access. While not a substitute for the INKS authentication model, the S/WAN provides an additional layer of security as required by some organizations.
Disparate relational databases (RDBMS) on various platforms refresh the XML repository periodically using LDAP. The actual data sources are administered, maintained, owned, and provided by their respective owners (publishers). Data from the data sources (RDBMS) are cached in the data application layer which functions to transfer information from data sources and store it on a separate server. This provides isolated instances of data access for security and permits the encrypted data to be rapidly exchanged with Tier 2 using tunneling in remote sessions over a virtual private network (VPN). Each owner/publisher must protect his information according to their organizational policies and one should not prematurely connect valuable data. Once it has been shown that the data sources made available from publishers (e-books, research, multimedia archives) can be securely accessed using the XML repository for education, then more sensitive data found in government, intelligence and business can be considered. Each data archive in the XML repository connects disparate data sources.
